(19) United States
(12) Patent Application Publication
(10) Pub. No.: US 2023/0231268 A1
(43) Pub. Date: Jul. 20, 2023

(54) SUPPRESSION OF SAFETY GASES

(71) Applicant: Carrier Corporation, Palm Beach Gardens, FL (US)

(72) Inventors: Karl Fredrik Penden, Rumford, RI (US); John Kliem, Wayland, MA (US)

(21) Appl. No.: 18/152,526

(22) Filed: Jan. 10, 2023

Related U.S. Application Data
(60) Provisional application No. 63/300,415, filed on Jan. 18, 2022.

(51) Int. Cl. H01M 50/383

(52) U.S. Cl. CPC H01M 50/383; H01M 50/213

(57) ABSTRACT

A system includes a battery mounting area, a venting area fluidly isolated from the battery mounting area, and a battery cell arranged at least partially within the battery mounting area. The battery cell includes at least one safety vent that is fluidly coupled to the venting area.

### CROSS-REFERENCE TO RELATED APPLICATIONS

This application claims the benefit of U.S. Provisional Application No. 63/300,415 filed Jan. 18, 2022, the disclosure of which is incorporated herein by reference in its entirety.

### BACKGROUND

Exemplary embodiments pertain to the art of lithium ion batteries, and more particularly, to a battery energy storage system.

Existing lithium ion battery cells are equipped with a safety vent. When the battery cell undergoes a thermal event, the pressure within the battery cell can exceed a threshold value. In such instances, the safety vent is configured to relieve the internal pressure of the battery cell by venting materials, such as gases, liquid, and solids into the air surrounding the battery cells. However, the materials that are vented are typically flammable. If these materials are ignited, the resulting fire event could heat up the neighboring battery cells causing a cascading thermal event to occur. Further, the accumulation of the exhausted materials within the area surrounding the battery cells may achieve a concentration which may create a potential risk of explosion.

### BRIEF DESCRIPTION

According to an embodiment, a system includes a battery mounting area, a venting area fluidly isolated from the battery mounting area, and a battery cell arranged at least partially within the battery mounting area. The battery cell includes at least one safety vent that is fluidly coupled to the venting area.

In addition to one or more of the features described herein, or as an alternative, in further embodiments the venting area is located directly adjacent to the battery mounting area.

In addition to one or more of the features described herein, or as an alternative, in further embodiments the venting area is located remotely from the battery mounting area.

In addition to one or more of the features described herein, or as an alternative, in further embodiments the battery cell further comprises a battery can having a first open end, a second closed end, and a sidewall extending between the first open end and the second closed end; and a cap affixed to the battery can adjacent to the first open end.

In addition to one or more of the features described herein, or as an alternative, in further embodiments the at least one safety vent is formed in the sidewall.

In addition to one or more of the features described herein, or as an alternative, in further embodiments the at least one safety vent is formed in the cap.

In addition to one or more of the features described herein, or as an alternative, in further embodiments the at least one safety vent is directly coupled to the venting area.

In addition to one or more of the features described herein, or as an alternative, in further embodiments a portion of the battery cell including the at least one safety vent is arranged within the venting area.

In addition to one or more of the features described herein, or as an alternative, in further embodiments comprising a conduit extending between the at least one safety vent and the venting area such that the at least one safety vent is indirectly coupled to the venting area.

In addition to one or more of the features described herein, or as an alternative, in further embodiments comprising a movement mechanism operable to move exhaust materials output from the at least one safety vent to the venting area.

In addition to one or more of the features described herein, or as an alternative, in further embodiments comprising an inerting system in fluid communication with the venting area, the inerting system including: at least one spray nozzle, a source of inerting agent, and a delivery piping system fluidly connecting the source of inerting agent and the at least one spray nozzle.

In addition to one or more of the features described herein, or as an alternative, in further embodiments comprising a suppression system in fluid communication with the venting area, the suppression system including at least one spray nozzle, a source of suppression agent, and a delivery piping system fluidly connecting the source of suppression agent and the at least one spray nozzle.

According to an embodiment, a method of managing a battery energy storage system includes operating a battery cell arranged within a battery mounting area and venting an exhaust material from the battery cell in response to a thermal event. Venting the exhaust material from the battery cell further comprises venting the exhaust material to a venting area fluidly isolated from the battery mounting area.

In addition to one or more of the features described herein, or as an alternative, in further embodiments venting the exhaust material to the venting area further comprises venting the exhaust material directly to the venting area.

In addition to one or more of the features described herein, or as an alternative, in further embodiments venting the exhaust material to the venting area further comprises venting the exhaust material to the venting area via a conduit extending between the battery cell and the venting area.

In addition to one or more of the features described herein, or as an alternative, in further embodiments comprising inerting the exhaust material within the venting area via an inerting system.

In addition to one or more of the features described herein, or as an alternative, in further embodiments comprising suppressing a fire within the venting area via a suppression system.

In addition to one or more of the features described herein, or as an alternative, in further embodiments venting the exhaust material to the venting area fluidly isolated from the battery mounting area further comprises drawing the exhaust material into the venting area via a movement mechanism.

In addition to one or more of the features described herein, or as an alternative, in further embodiments venting of the exhaust material occurs in response to an increase in a pressure within the battery cell in response to the thermal event.

In addition to one or more of the features described herein, or as an alternative, in further embodiments venting of the exhaust material occurs when the pressure within the battery cell exceeds a predetermined threshold.

### BRIEF DESCRIPTION OF THE DRAWINGS

The following descriptions should not be considered limiting in any way. With reference to the accompanying drawings, like elements are numbered alike:

FIG. 1 is a schematic diagram of an exemplary battery cell according to an embodiment;

FIG. 2 is a schematic diagram of an exemplary battery energy storage system according to an embodiment;

FIG. 3 is a schematic diagram of an exemplary battery energy storage system according to another embodiment; and

FIG. 4 is a schematic diagram of an exemplary battery energy storage system and an inerting and/or suppression system associated with the battery energy storage system according to an embodiment.

### DETAILED DESCRIPTION

A detailed description of one or more embodiments of the disclosed apparatus and method are presented herein by way of exemplification and not limitation with reference to the Figures.

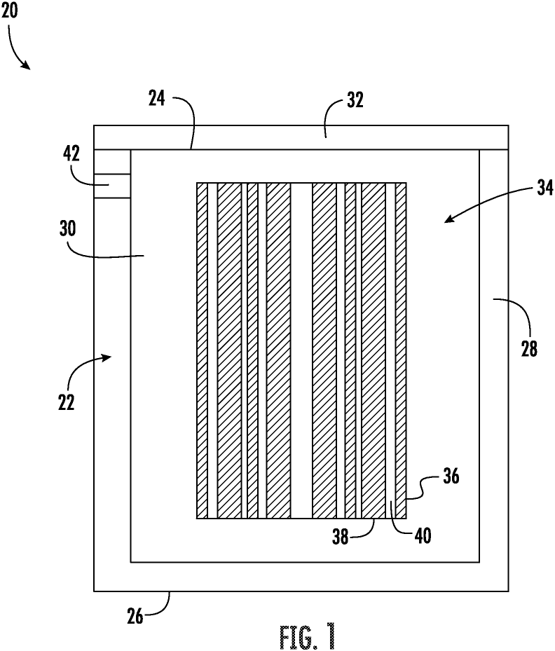

With reference now to FIG. 1, an exemplary battery 20, such as a lithium ion battery for example, is illustrated. As shown, the battery 20, also referred to herein as a cell or battery cell, includes a battery housing or can 22. The battery can 22 may have a first open end 24, a second sealed end 26, and at least one sidewall 28 extending between the first end 24 and the second end 26 to define a hollow interior 30 therein. Further, the battery can 22 may be formed from any suitable material, including but not limited to a metal material. Although the battery can 22 illustrated in the FIGS. is generally rectangular in shape, it should be understood that embodiments where the battery can 22 has another configuration, such as where the battery can 22 is cylindrical in shape for example, are also within the scope of the disclosure. A cap or lid 32 is connected to the first open end 24 of the battery can 22 to seal the hollow interior 30. In an embodiment, the cap 32 is a generally flat panel and has a size and shape corresponding to the size and shape of the battery can 22. The cap 32 may, but need not be formed from the same material as the battery can 22.

A battery unit, illustrated schematically at 34, is arranged within the hollow interior 30 of the battery can 22. The battery unit 34 includes an electrode assembly having a positive electrode 36 and a negative electrode 38. The positive and negative electrodes 36, 38 may be sheets stacked on top of one another and separated from one another by a separator 40 to form the battery unit 34. Furthermore, the stacked positive electrode 36, separator 40, and negative electrode 38, may be wound into a coil prior to installation within the hollow interior 30 of the battery can 22.

At least one safety vent 42 may be located at a surface of the battery can 22. Although the safety vent 42 in FIG. 1 is illustrated as being positioned near the first end 24 of the battery can 22, embodiments including a safety vent 42 arranged at another location of the battery can 22, such as at the sidewall 28 thereof for example, and/or embodiments where a safety vent 42 is formed in the cap 32 are also within the scope of the disclosure. During normal operation of the battery cell 20, the safety vent 42 is closed such that the interior 30 of the battery can 22 remains hermetically sealed. However, when necessary, such as when a pressure within the interior 30 of the battery can 22 reaches a predetermined threshold due to an abnormality of the battery cell 20 for example, the safety vent 42 is automatically activated. Activation of the safety vent 42 may include opening the safety vent 42 to exhaust material, such as one or more of gases, liquids, and solids, from the interior 30 of the battery can 22, thereby reducing the pressure within the battery can 22. The battery cell 20 illustrated and described herein is intended as an example only and it should be understood that a lithium ion battery cell 20 having another configuration is also contemplated herein.

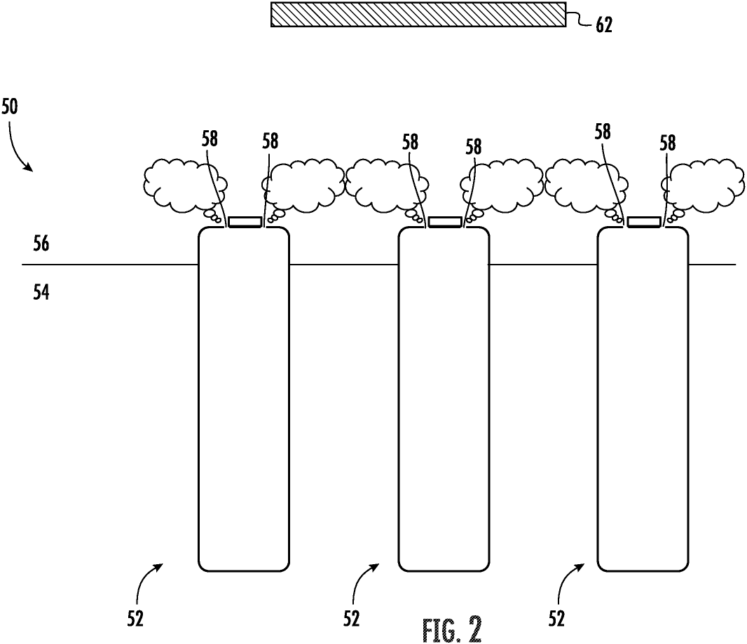

With reference now to FIGS. 2-4, an exemplary battery energy storage system (BESS) 50 including one or more battery cells 52 is illustrated. In the illustrated, non-limiting embodiment, the BESS 50 includes a plurality of substantially identical battery cells 52, such as similar to battery cell 20, for example. However, embodiments where a configuration of one or more of the battery cells 52 varies relative to another of the battery cells 52 is within the scope of the disclosure. In addition, although the BESS shown 50 in the FIGS. includes a plurality of battery cells 52. it should be understood that a BESS 50 having a single battery cell is also within the scope of the disclosure.

As shown, the BESS includes a first space or area 54, also referred to herein as a battery mounting area, and at least a portion of one or more of the battery cells 52 is mounted within battery mounting area 54. In the illustrated, non-limiting embodiment, a majority or substantially entirety of each of the plurality of battery cells 52 is arranged within the battery mounting area 54. In an embodiment, the BESS 50 includes a second space or area 56, also referred to herein as a venting area, that is fluidly isolated from the battery mounting area 54. The venting area 56 may be located directly adjacent to the battery mounting area 54 as shown in the FIGS., or alternatively, may be located remotely from the battery mounting area 54.

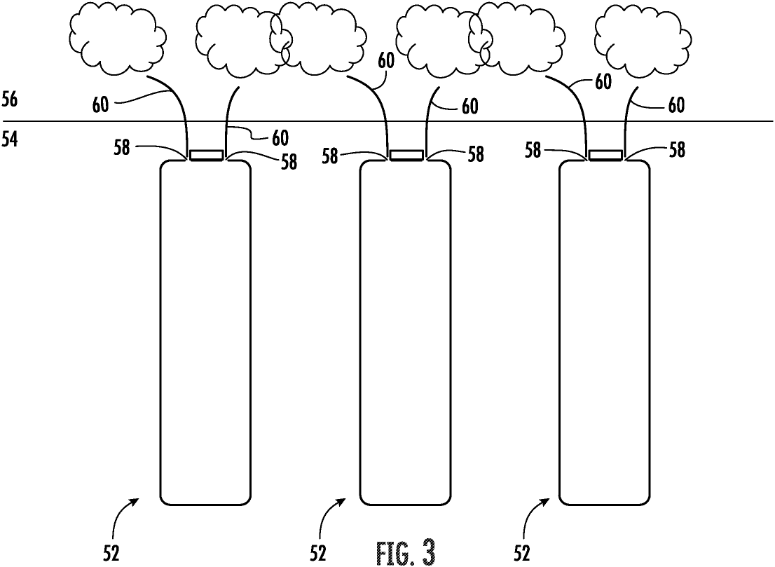

The battery cell 52 is positioned such that at least one safety vent(s) 58 of at least one battery cell 52 is arranged in fluid communication with the venting area 56. In the illustrated, non-limiting embodiment of FIG. 2, each battery cell 52 includes two safety vents 58 and both safety vents 58 of each battery cell 52 are arranged within the venting area 56. In such embodiments, the exhaust materials that are released from the battery cell 52 via the safety vents 58 are released directly into the venting area 56 from the interior of the battery cell 52. In another embodiment, best shown in FIG. 3,a safety vent 58 of one or more of the battery cells 52 is indirectly fluidly coupled to the venting area 56 by a pipe or other conduit 60. By positioning the safety vent 58 in fluid communication with the venting area 56, the exhaust materials are configured to flow into the venting area 56 as a result of the pressure within the battery cell 52. However, embodiments where one or more movement mechanisms 62, such as a fail for example, is configured to further facilitate the flow of the exhaust materials towards the venting area 56 are also within the scope of the disclosure. In such embodiments the movement mechanism 62 may be arranged within the vent area 56, as shown in FIG. 2.

By directing the exhaust gasses and other materials from the battery cells 52 into the venting area 56, the flammable and/or explosive exhaust gasses and other materials are substantially isolated from the battery cells 52 of the BESS 50. As a result, the thermal runaway of a battery cell 52 would not have a cascading effect on the adjacent battery cells 52, and the potential occurrence of a fire event within the battery mounting area 54 is significantly reduced.

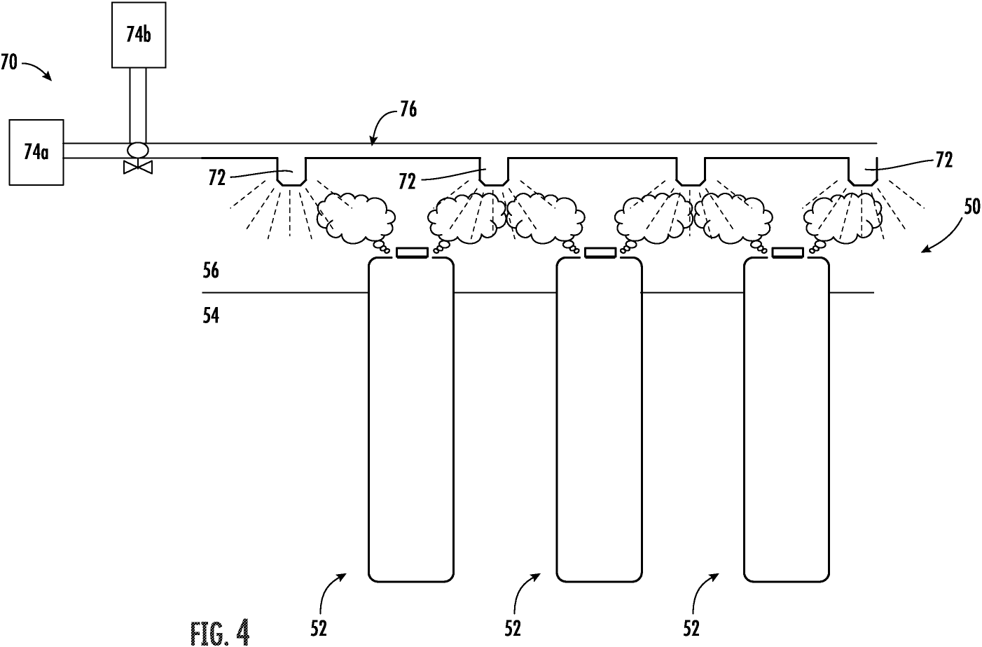

With reference now to FIG. 4, in an embodiment, an inerting and/or suppression system 70 is arranged in fluid communication with the venting area 56. As shown, the inerting or suppression system 70 includes at least one spray nozzle 72 associated with the venting area 56 and a source of a suppression agent 74a and/or a source of inerting agent 74b. In an embodiment, the sources of suppression agent and inerting agent 74a, 74b are in the form of self-contained pressure vessels. Examples of suitable suppression agents or inerting agents include, but are not limited to water, clean agent, inert gas or other approved media. The source of suppression agent 74a and/or the source of inerting agent 74b is arranged in fluid communication with the nozzles 72 via a delivery path defined by a delivery piping system 76. Upon detection of the presence of exhaust materials within the venting area 56, inerting agent from the source thereof 74b, is allowed to flow through the delivery piping system 76 to the one or more spray nozzles 72 for release directly into the venting area 56. Accordingly, the system 70 may be configured to inert the exhaust materials as they are evacuated from the BESS into the venting area 56. Upon detection of smoke, fire, or an explosion within the venting area 56, the suppression agent from the source of suppression agent 74a is allowed to flow through the delivery piping system 76 to the one or more spray nozzles 72 for release directly into the venting area 56. Such operation of the system 70 prevents, or at least mitigates, flames present in the venting area from spreading back into the battery cell 52 or into the BESS 50.

Although a single system 70 is illustrated and described herein as being operable to perform both inerting and fire suppression, it should be understood that embodiments where the system 70 is configured to perform only one of inerting and fire suppression are also contemplated herein. In such embodiments, a secondary system having a similar or different configuration may be arranged in fluid communication with the venting area 56 to perform the other of the inerting and fire suppression.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a battery mounting area;
a venting area fluidly isolated from the battery mounting area; and
a battery cell arranged at least partially within the battery mounting area, the battery cell including at least one safety vent, the at least one safety vent being fluidly coupled to the venting area.

2. The system of claim 1, wherein the venting area is located directly adjacent to the battery mounting area.

3. The system of claim 1, wherein the venting area is located remotely from the battery mounting area.

4. The system of claim 1, wherein the battery cell further comprises:
a battery can having a first open end, a second closed end, and a sidewall extending between the first open end and the second closed end; and
a cap affixed to the battery can adjacent to the first open end.

5. The system of claim 4, wherein the at least one safety vent is formed in the sidewall.

6. The system of claim 4, wherein the at least one safety vent is formed in the cap.

7. The system of claim 1, wherein the at least one safety vent is directly coupled to the venting area.

8. The system of claim 7, wherein a portion of the battery cell including the at least one safety vent is arranged within the venting area.

9. The system of claim 1, further comprising a conduit extending between the at least one safety vent and the venting area such that the at least one safety vent is indirectly coupled to the venting area.

10. The system of claim 1, further comprising a movement mechanism operable to move exhaust materials output from the at least one safety vent to the venting area.

11. The system of claim 1, further comprising an inerting system in fluid communication with the venting area, the inerting system including:
at least one spray nozzle;
a source of inerting agent; and
a delivery piping system fluidly connecting the source of inerting agent and the at least one spray nozzle.

12. The system of claim 1, further comprising a suppression system in fluid communication with the venting area, the suppression system including:
at least one spray nozzle;
a source of suppression agent; and
a delivery piping system fluidly connecting the source of suppression agent and the at least one spray nozzle.

13. A method of managing a battery energy storage system comprising:
operating a battery cell arranged within a battery mounting area; and
venting an exhaust material from the battery cell in response to a thermal event, wherein the venting the exhaust material from the battery cell further comprises venting the exhaust material to a venting area fluidly isolated from the battery mounting area.

14. The method of claim 13, wherein venting the exhaust material to the venting area further comprises venting the exhaust material directly to the venting area.

15. The method of claim 13, wherein venting the exhaust material to the venting area further comprises venting the exhaust material to the venting area via a conduit extending between the battery cell and the venting area.

16. The method of claim 13, further comprising inerting the exhaust material within the venting area via an inerting system.

17. The method of claim 13, further comprising suppressing a fire within the venting area via a suppression system.

18. The method of claim 13, wherein venting the exhaust material to the venting area fluidly isolated from the battery mounting area further comprises drawing the exhaust material into the venting area via a movement mechanism.

19. The method of claim 13, wherein the venting of the exhaust material occurs in response to an increase in a pressure within the battery cell in response to the thermal event.

20. The method of claim 19, wherein venting of the exhaust material occurs when the pressure within the battery cell exceeds a predetermined threshold.
